(19) United States
(12) Patent Application Publication
(10) Pub. No.: US 2004/0074937 A1
(43) Pub. Date: Apr. 22, 2004

(54) Combination backpack and child seat for a vehicle

(76) Inventor: Lora Lee Thomas, Berrien Springs, MI (US)

Correspondence Address: Eric D. Cohen, Welsh & Katz, Ltd., 22nd Floor, 120 South Riverside Plaza, Chicago, IL, 60606, US

(21) Appl. No.: 10/654,077

(22) Filed: Sep. 3, 2003

Related U.S. Application Data
(60) Provisional application No. 60/407,882, filed on Sep. 3, 2002.

(51) Int. Cl. A45F 4/02; A61G 1/00; A45F 3/04; A45F 3/08; A45F 3/10

(52) U.S. Cl. 224/155; 224/161; 224/628

(57) ABSTRACT

A combination backpack configured to be worn about the torso of a user, and a child seat for a vehicle, includes a first closable pocket portion having a front face, which is configured to retain a cushion therein. Two shoulder straps each attached to upper and lower ends of opposite sides of the front face of the first pocket portion are configured to be worn about the torso of the user when used as a backpack. The combination includes a second closable pocket portion adjacent the first pocket portion, a rigid seatback support configured to be retained in the second closable pocket portion, and a child harness assembly releasably attached to the seatback support. When the second pocket is in an open position and the front face of the first pocket is placed on a vehicle seat, the cushion functions as a seat bottom for the child seat and the seatback support functions as a back support for the child seat.

### CROSS-REFERENCE TO RELATED APPLICATIONS

This application claims the benefit of priority from copending provisional patent application Serial No. 60/407,882, filed on Sep. 9, 2002, entitled Backpack Booster and Car Seat Combination. Provisional patent application Serial No. 60/407,882 is incorporated herein by reference in its entirety.

### FIELD OF THE INVENTION

The present invention relates generally to a car seat for a child and more specifically to a child or toddler car seat that functions as a child seat and/or booster seat, and which can be carried as a backpack.

### BACKGROUND

Many known child seats and booster seats exist for use inside a vehicle. However, individuals purchasing a child seat may need to purchase another seat, such as a booster seat, when the child grows larger. This is relatively costly. Additionally, it is cumbersome to carry such child seats and boosters seats when away from the vehicle if the seats are not to be left in the vehicle. Accordingly, it is desirable to provide a vehicle seat that functions as a child seat and a booster seat and which can be stored as part of a backpack.

### SUMMARY

The disadvantages of present child car seats arrangements may be substantially overcome by providing a novel car seat, booster seat and backpack. More specifically, in one embodiment, a combination child seat and backpack is provided. The backpack is configured to be worn about the torso of a user, and the child seat is configured to rest upon and be secured to a standard vehicle seat. The combination includes a first closable pocket portion having a front face, which is configured to retain a cushion therein. Also included are two shoulder straps attached to upper and lower ends of opposite sides of the front face of the first pocket portion. The shoulder straps are configured to be worn about the torso of the user when the combination is used as a backpack. A second closable pocket portion is disposed adjacent the first pocket portion, and a rigid seatback support is configured to be retained in the second closable pocket portion. A child harness assembly is releasably attached to the seatback support. When the second pocket is in an open position and the front face of the first pocket is placed on a vehicle seat, the cushion functions as a seat bottom for the child seat, and the seatback support functions as a back support for the child seat.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a perspective view of a specific embodiment showing a backpack, according to the present invention;

FIG. 2 is a perspective view of a specific embodiment of a combination backpack in an open configuration showing a child car seat;

FIG. 3 is a perspective view of a specific embodiment of a combination backpack in an open configuration showing a child car seat and particularly illustrating a back plate;

FIG. 4 is a perspective view of a specific embodiment of a combination backpack in an open configuration showing a child car seat and particularly illustrating arm supports;

FIG. 5 is a perspective view of a specific embodiment of a combination backpack in an open configuration showing a child car seat and particularly illustrating side head protectors;

FIG. 6 is a perspective view further showing the side head protectors of FIG. 5;

FIG. 7 is a perspective view of a specific embodiment of a combination backpack in an open configuration showing a child car seat and particularly illustrating seat belt guides;

FIG. 8 is an enlarged view of the seat belt guides of FIG. 7; and

FIG. 9 is a perspective view of a specific embodiment of a combination backpack in an open configuration showing use as a booster seat for a larger child.

### DETAILED DESCRIPTION

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

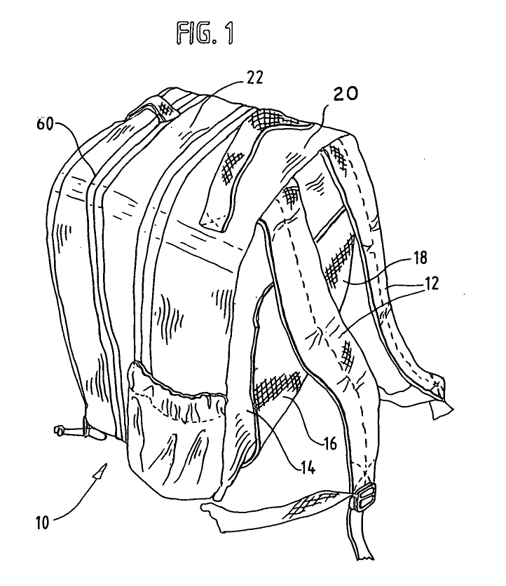

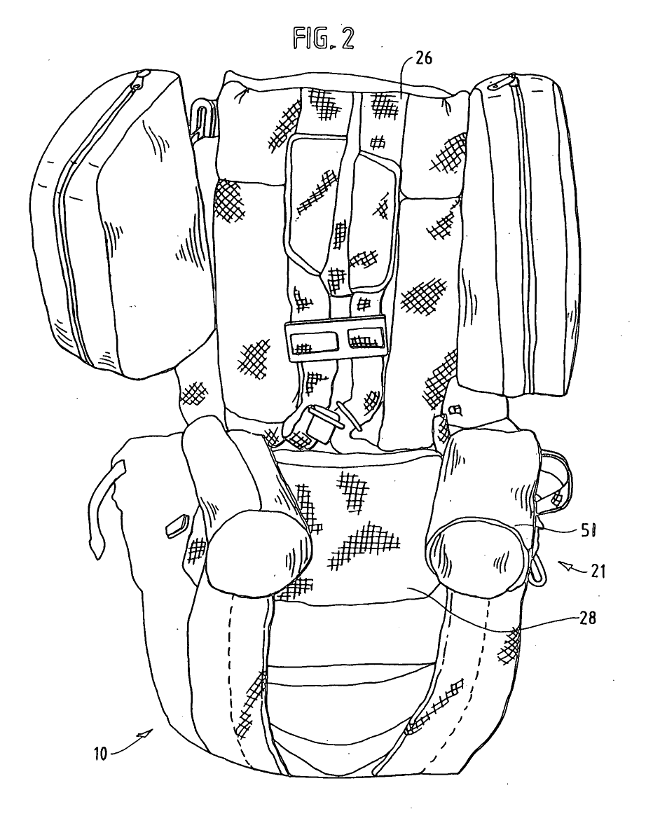

Referring now to FIGS. 1-4, FIG. 1 shows a backpack 10 generally in the closed configuration, while FIG. 2 shows the backpack 10 in the open position so as to function as a child seat. The backpack 10 has two closed loops or shoulder straps 12 attached to opposite sides of a back portion 14 of the backpack, and are attached at upper an lower portions of the backpack. In the closed position, the backpack is worn by the user as a conventional backpack. The shoulder straps 12 are brought forward to encircle the torso or shoulders of the user so that a back face portion 16 of the backpack is adjacent the back of the user. The back face portion may be formed of or covered by a non-skid or non-slip material 18, as will be discussed below.

The backpack has at least three zippered compartments. A first zippered or closable compartment 20 is configured to retain a cushion or other support. This compartment generally remains closed in operation so as to retain the cushion. The cushion may be tapered so that it may be, for example, five inches thick at the front, and 2.5 inches thick at the back.

When the backpack is appropriately configured, that is, in an “open configuration,” it may be used as a child seat 21. Typically, the child seat 21 is used for children in the twenty to eighty pound range, and is configured to be a “forward facing” child seat. In is not intended to be used with infants, which require “backward facing” seats, as set forth by Federal regulations. In operation as a child seat, the back face portion of the backpack is placed on the existing vehicle seat. Accordingly, the non-slip material is in contact with the vehicle seat so that the backpack/child seat resists movement relative to the surface of the vehicle seat.

When used as a child seat, a second zippered or closable compartment 22, adjacent the first compartment 20, is opened to expose a child seat back portion 26 therein. Note that the “inside” of the second compartment 22 may also be made of or covered by non-skid or non-slip material 28. The child essentially sits on this portion with his or her legs extending forward along the inside portion. This further helps to prevent movement of the child in a forward direction during sudden deceleration of the vehicle.

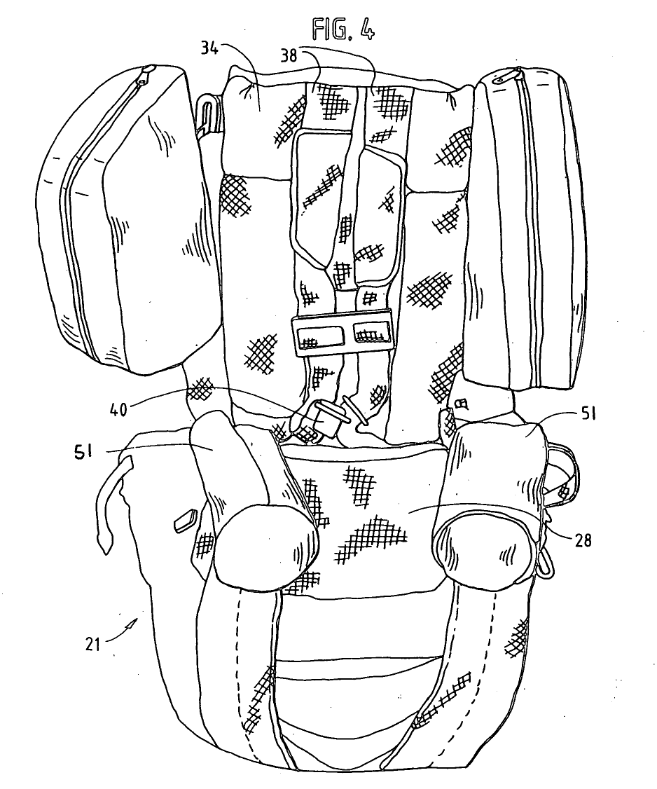

The seat back portion 26 includes a rigid molded plastic back plate 30 that provides back support for the child sitting on the child seat. However, the back portion 26 may be formed of any suitable rigid material This also functions as a safety feature. A harness assembly or “vest” 34, preferably made of cloth material, is removably secured to the back plate. The harness assembly 34 provides additional cushioning for the child's back and also provides child seat belt portions 38 in the form or small shoulder straps appropriately sized to fit a child and to secure the child in the child seat 21. Preferably, the child seat belt portions 38 are removeably affixed to the back plate 30 and completely loop around the back plate 30 along its length from top to bottom. As shown in FIG. 4, the child seat belt portions may fasten toward the bottom of the seat by mating with a corresponding fastener clip 40, thus forming a closed “loop” around the child relative to the back plate. Preferably, the two child seat belt portions converge at the fastener clip 40.

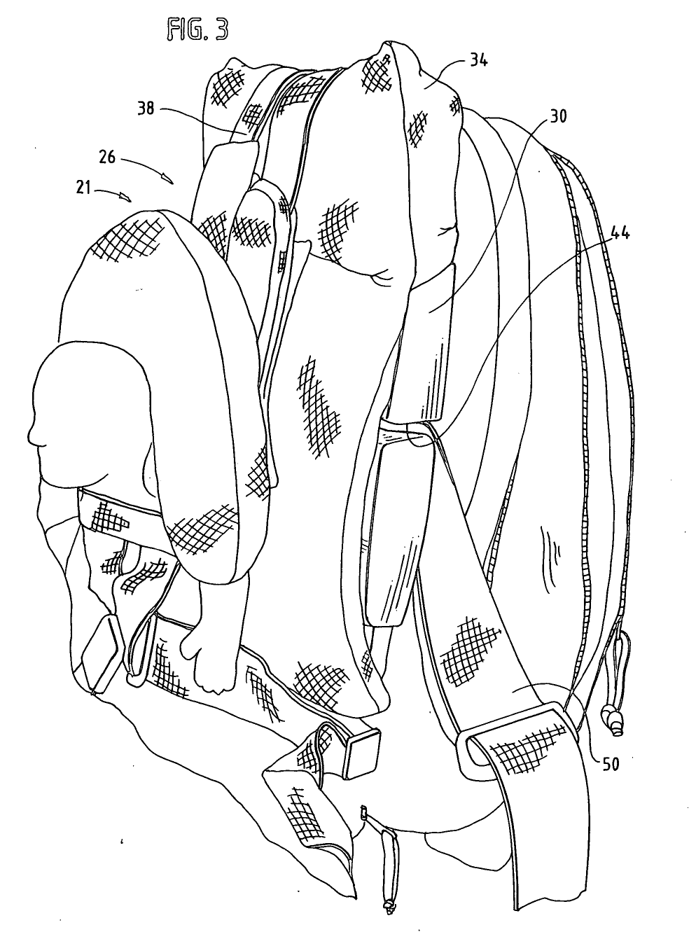

To secure the back plate 30, and hence the entire child seat 21 and child, relative to the vehicle seat upon which it rests, a plurality of slots 44 or grooves are integrally formed in the back plate 30. The slots may be placed at the top, middle, or bottom of the sides of the back plate 30 so as to accommodate a variety of seatbelt configurations. The slots 44 are configured to receive and guide therethrough, the standard vehicle seat belts 50 (FIG. 3). In that regard, the standard vehicle seat belt 50 is passed through the slots in the back plate 30, but in front of the back plate and behind the harness assembly 34. Thus, during sudden deceleration of the vehicle, the standard vehicle seatbelt retains the back plate 30. In turn, the harness assembly 34 secured to the back plate 30 retains the child. Thus, the standard vehicle seat belt 50 is not in contact with the child. The slots 44 in the back plate are dimensioned and located to accommodate a standard lap seat belt and/or a shoulder/lap combination belt arrangement.

The shoulder straps 12 of the backpack 10 may have additional padding and/or stiffeners 50, as more clearly shown in FIG. 4. When the shoulder straps and padding 50 are brought upwards and away from the back portion 14 of the back pack, the padding may provide the child with arm rests or arm supports, as best shown in FIGS. 2 and 4.

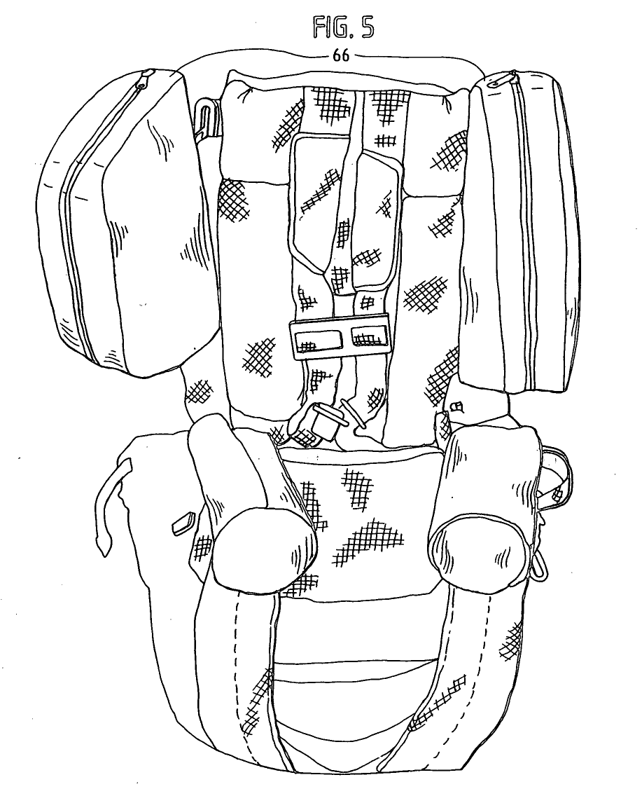

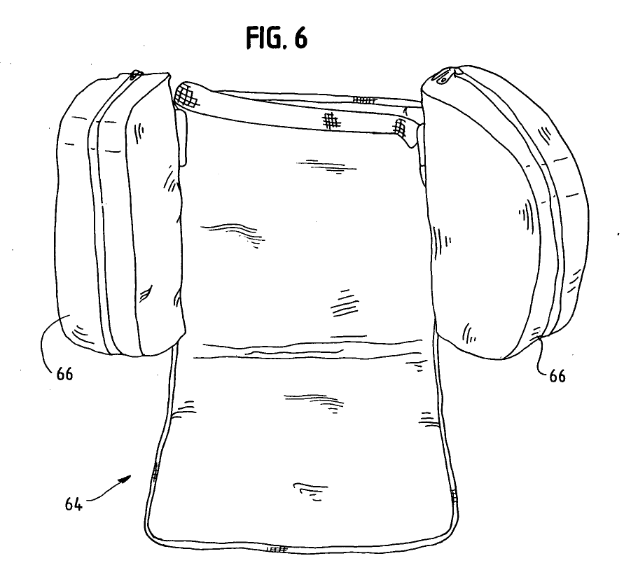

Referring now to FIGS. 1, 5-8, a third zippered or closable compartment 60 (FIG. 1) adjacent the second compartment 28 is configured to house an adjustable pad assembly 64 having additional side head protectors 66. The top portion of the adjustable pad assembly 64 may be cushioned to provide a head rest for the child. Alternatively, the side head protectors 66 may be folded inwardly and covered with a top portion of the assembly to provide a head rest.

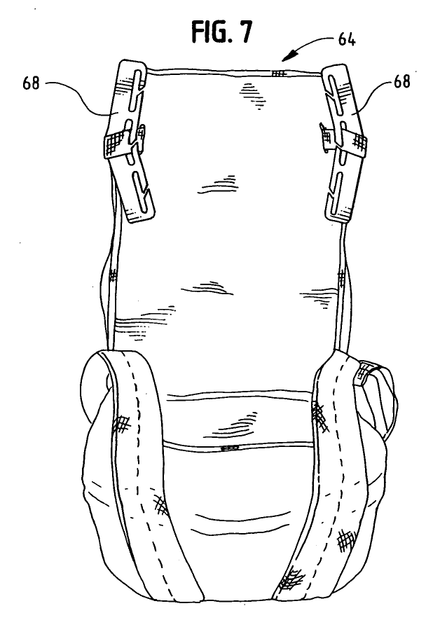

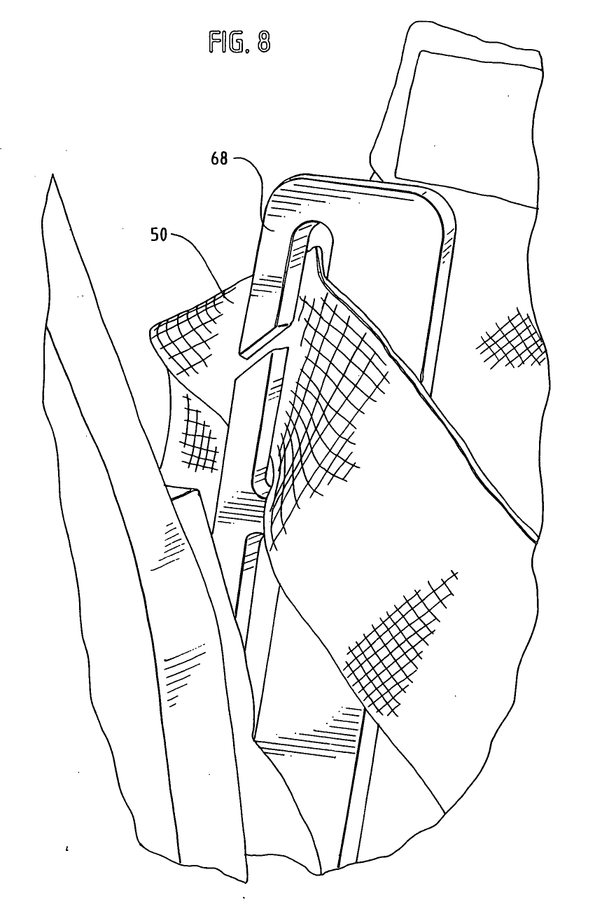

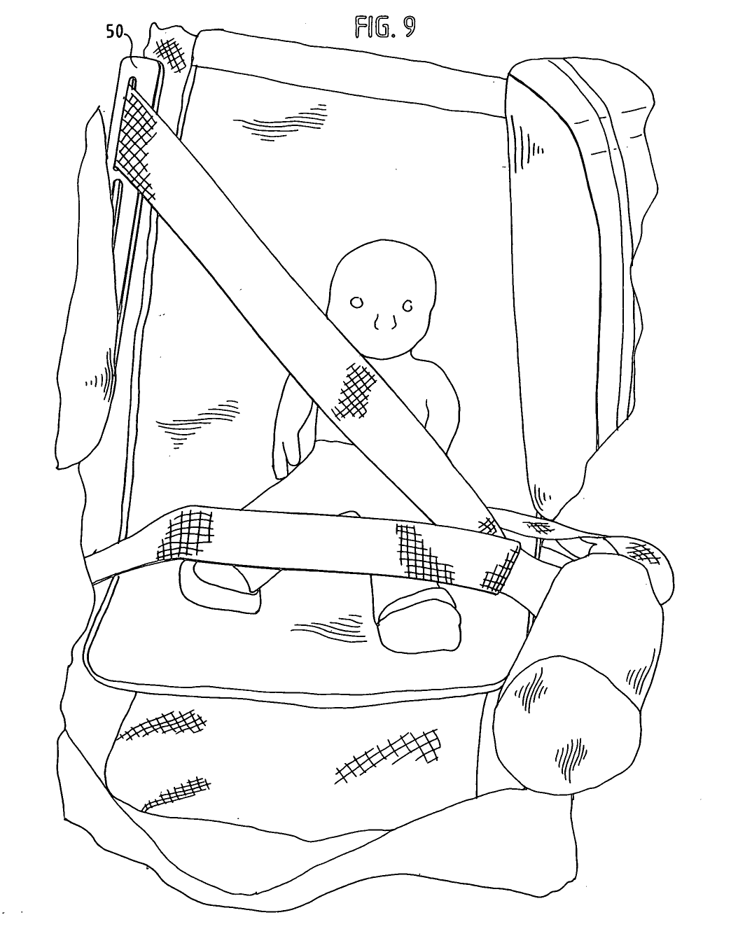

Using the adjustable pad assembly 64, the child seat may function as a booster seat to accommodate a larger child, as mentioned above. The adjustable pad assembly 64 may further include side seatbelt fasteners 68 (FIGS. 7-8) having slots configured to receive and guide the shoulder/lap seatbelt combination 50 of the vehicle over and diagonally across the larger child, as best shown in FIG. 9. In this configuration, the standard three point combination seatbelts 50 may be used to secure the child within the child seat 21, rather than using the child seat belt portions 38 of the harness assembly 34.

Specific embodiments of a combination car seat, booster seat, and backpack according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. In combination, a backpack configured to be worn about the torso of a user, and a child seat for a vehicle, the combination comprising:
a first closable pocket portion having a front face, and configured to retain a cushion therein;
two shoulder straps each attached to upper and lower ends of opposite sides of the front face of the first pocket portion, the straps configured to be worn about the torso of the user when the combination is used as a backpack;
a second closable pocket portion adjacent the first pocket portion;
a rigid seatback support configured to be retained in the second closable pocket portion;
a child harness assembly releasably attached to the seatback support;
wherein when the second pocket is in an open position and the front face of the first pocket is placed on a vehicle seat, the cushion functions as a seat bottom for the child seat and the seatback support functions as a back support for the child seat.
